(19) United States
(12) Patent Application Publication
(10) Pub. No.: US 2004/0060396 A1
(43) Pub. Date: Apr. 1, 2004

(54) Starting material for saw blades or saw bands

(75) Inventors: Gerhard Tichler, Bohlerwerk (AT); Gregor Innitzer, Vienna (AT)

Correspondence Address: GREENBLUM & BERNSTEIN, P.L.C., 1950 ROLAND CLARKE PLACE, RESTON, VA, 20191, US

(73) Assignee: Bohler Ybbstal Band GmbH & Co. KG, Bohlerwerk (AT)

(21) Appl. No.: 10/637,506

(22) Filed: Aug. 11, 2003

(30) Foreign Application Priority Data
Aug. 12, 2002 (AT) 1219/2002

(51) Int. Cl. B23D 63/00; B27B 13/02

(52) U.S. Cl. 76/112; 83/835

(57) ABSTRACT

A starting material for the production of a saw band which comprises saw teeth with tooth tips of hard, wear-resistant material and a process for the production thereof. The starting material comprises a steel band which carries on the face side thereof individual parts of cutting material which correspond to the tooth tips of the saw band. This abstract is neither intended to define the present invention disclosed in this specification nor intended to limit the scope in any way.

### CROSS-REFERENCE TO RELATED APPLICATIONS

The present application claims priority under 35 U.S.C. §119 of Austrian Patent Application No. A 1219/2002, filed on Aug. 12, 2002, the disclosure of which is expressly incorporated by reference herein in its entirety.

### BACKGROUND OF THE INVENTION

1. Field of the Invention

The invention relates to a starting material for the production of a saw band or a saw blade of tough, elastic steel, in which the saw teeth have tooth tip areas of hard, wear-resistant material and to a process for producing such a starting material.

2. Discussion of Background Information

In general, a composite steel blade or steel band is used as the starting material for manufacturing saws with hard and wear-resistant tooth tip areas. In its cross section, such a composite steel blade/band shows a narrow part of tool steel on the narrow side of an elastically flexible saw part or carrier part. The parts are metallically joined together by means of generally additive-free fusion welding.

This starting material, which is called a bimetal band or bimetal blade by those skilled in the art, is produced by a joint welding of the bands or parts in the longitudinal direction, preferably by means of an electron beam or laser beam welding process.

Making a saw from the starting material is essentially carried out by working the intended tooth profile from the band area with the tool steel part thereon right into the carrier part, so that only the tip areas of the teeth are made of tool steel or cutting material, which areas can ultimately be hardened by heat treatment.

It is also known to produce a so-called trimetal band as a starting material for saws, wherein cutting steel layers are welded onto both face sides of a carrier band, whereafter the band is split in the lengthwise direction and the teeth are worked into that side of the band which carries the tool steel material.

The advantages of a starting material in which a carrier band is bonded or welded continuously with a cutting tool band comprise that the joint welding is carried out without interruption, and defects are eliminated to the greatest possible extent. This starting material embodiment can even be used advantageously in the case of a saw toothing with irregular tooth spacing, which may be desirable in order to avoid vibrations of the saw in practical use.

As mentioned, the welding together of the carrier band and the cutting material band takes place directly, i.e., free of welding additives, and the welding process produces only thin, heat-affected zones. However, since a fusion-welded connection is produced across the entire band length, thin, brittle martensite layers and/or length changes can occur, in particular with coarser bands, which may also cause an elastic bending of the band in the width direction. Furthermore, with improper manipulation thin, brittle layers can promote crack initiation and destabilize the connection of the tooth tips to the saw. To avoid such problems and for structural conditioning purposes, the starting material band frequently is subjected to at least one annealing operation.

In a saw manufacturing process, the gap between the teeth can be ground out, punched out or milled out from a bimetal starting material blade or similar starting material band. In any case, the entire, relatively hard cutting material area between the tooth tips is to be removed thereby.

A removal or a taking away of the material, in particular, of the cutting material part during the production of the gaps between the working teeth from a bimetal band or bimetal blade stack strains the tools considerably, resulting in an increased processing time and an increased tool wear.

In view of the foregoing, it would be desirable to be able to avoid the above shortcomings and to provide a starting material for the production of a saw blade or saw band with tooth tips of hard, wear-resistant material that shows lower mechanical strains and maximum connection quality in the welding area of the tooth tip part, and requires shorter machining time and causes lower tool wear during saw manufacture.

It would also be desirable to have available a process for the cost-effective production of a starting material for a saw blade or saw band with hard, wear-resistant tooth tips of improved quality.

### SUMMARY OF THE INVENTION

The present invention provides a starting material for the production of a saw band of tough, elastic steel which comprises saw teeth with tooth tips of hard, wear-resistant material. The starting material comprises a steel band which carries on the face side thereof (individual) parts of cutting material (here and in the following, including the appended claims, the terms “band” and “blade” are used interchangeably).

In one aspect, the parts of cutting material are situated at those locations on the steel band that correspond to the locations of the tooth tips on the saw band.

In another aspect, the parts of cutting material are connected to the steel band by, preferably, welding e.g., by electron beam welding, laser welding and/or resistance pressure welding.

In yet another aspect, the cutting material comprises a tool steel, e.g., a high-speed steel, and/or a hard metal.

In a still further aspect, the parts of cutting material are at least partially countersunk into depressions provided in the steel band.

In another aspect of the starting material of the present invention, the steel band has a width of greater than about 15 mm, e.g., greater than about 40 mm.

The present invention also provides a saw band made from the above starting material, including the various aspects thereof.

The present invention further provides a process for the manufacture of the above starting material, including the various aspects thereof. This process comprises placing parts of cutting material on the face side of a steel band and connecting the parts to the steel band by means of metallic bonding such as welding, e.g., at least one of electron beam welding, laser welding and resistance pressure welding.

In one aspect of the process, the parts of cutting material are placed in those locations on the steel band that correspond to the locations of the tooth tips on the saw band.

In another aspect of the process, there are substantially no gaps between the parts and the steel band.

In yet another aspect, depressions are provided in the steel band on the face side thereof and the parts of cutting material are at least partially countersunk into these depressions. Preferably, there are substantially no gaps between the parts and the bases of the depressions.

In still another aspect of the present process, the length of the individual parts of cutting material and/or the reciprocal spacing at which the parts are connected to the steel band and/or, where applicable, the length of the depressions in the steel band are provided in accordance with a predetermined tooth profile of the saw.

In a still further aspect, the steel band is guided and the parts of cutting material are placed thereon in sequence at predetermined points thereof and welded thereto or, where applicable, depressions are provided in the steel band at predetermined locations thereof, the steel band is guided, and the parts of cutting material are placed into the depressions and welded onto the steel band.

The present invention provides a starting material of the type mentioned at the outset, which starting material is made of a steel band that carries parts of cutting material on the face side thereof at those points that are to become the sites of the tooth tips on the saw made from the starting material.

The advantages of the starting material according to the invention include that on the narrow side of the carrier band only small areas, namely those that ultimately form the tooth tips, are connected to the cutting material portion, e.g., by metallic bonding such as fusion-welding. Thereby, the band stability and the elastic flexibility can be improved and savings in cutting material can be achieved. In the opinion of those skilled in the art connection defects can occur to an increased extent at the beginning of a welding seam, which, surprisingly, was not observed in the production of the starting material of the present invention. Rather, tests of fatigue strength under reversed bending stress and metallographic tests evidenced a significantly increased quality of the connection between the cutting material parts and the carrier material. Other types of metallic bonding include soldering, brazing and, in general, any method that provides a strong and durable connection between the carrier part and the cutting material parts.

A particularly high quality of the starting material can be achieved if the connection between the steel band or carrier part and the cutting material parts is formed by electron beam welding, laser welding or resistance pressure welding.

The cutting material for the saw band starting material of the present invention is advantageously made of tool steel, in particular, of high-speed steel, or hard metal, because particularly high cutting capacities of the resultant saw can be achieved thereby.

In order to provide a stabilization of the cutting material parts on the carrier band and a particularly high connection quality it may be advantageous in the manufacture of the starting material of the present invention and, ultimately, in the manufacture of the saw teeth, if the parts of cutting material are at least partially countersunk into the steel band on the face side thereof.

Especially from an economic point of view, it may be advantageous if the width of the steel band or carrier band is greater than about 15 mm, in particular, greater than about 40 mm.

According to the process for producing a saw band starting material according to the present invention, cutting material parts are placed without gaps onto a steel band on the face side thereof, i.e., at those sites at which tooth tips are ultimately to be present on the saw blade, and the cutting material parts are connected to the steel band by means of welding.

The advantages associated with this process include that a high flexibility can be achieved in the manufacture of the starting material, with a low storage volume for the cutting material parts. Moreover, due to the small-area contact between the cutting material parts and the carrier part, the highest possible safety in a joint welding process can be achieved.

In terms of manufacturing, as well as with regard to the highest possible precision of the positioning of the cutting areas, it may be advantageous to provide depressions in the steel band on the face side thereof, to place the cutting material parts into these depressions, with a substantially gap-free contact between these parts and the depressions, and to weld the parts and the band together.

If the welding of the cutting material parts to the steel band is carried out by means of electron beam, laser beam or resistance pressure welding, a safe connection as well as a direct control of the welding process can be achieved in a particularly advantageous manner.

A resistance pressure welding process is a connection process with direct flow of current through the contact area of the cutting material part on the carrier band.

An outstanding connection quality can be achieved if the cutting material parts are made of tool steel, preferably high-speed steel, in particular, high-alloy high-speed steel, preferably produced according to a powder metallurgical process, or of hard metal. This increase in quality also has a favorable effect on the manufacture of the saw teeth and the optional heat treatment of the base saw.

For a highly cost-effective manufacture of saws that feature a different tooth spacing, it may be advantageous if the length of the depressions on the face of the steel band and/or the length of the individual cutting material parts and/or their reciprocal spacing with which they are connected to the steel band on the face of the latter, are provided in accordance with the intended tooth profile of the saw.

In one of the embodiments of the process according to the invention, a steel band is guided and cutting material parts are placed thereon in sequence at predetermined points and welded thereto, or depressions are provided in the steel band and cutting material parts are placed into these depressions and are connected to the band by welding. Starting material economically produced in a so-called undivided product line additionally provides considerable quality advantages.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a starting material according to the invention in which cutting material parts are non-detachably attached to the face side surface of a steel band.

FIG. 2 shows a starting material according to the invention with cutting material parts partially recessed in a carrier blade.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

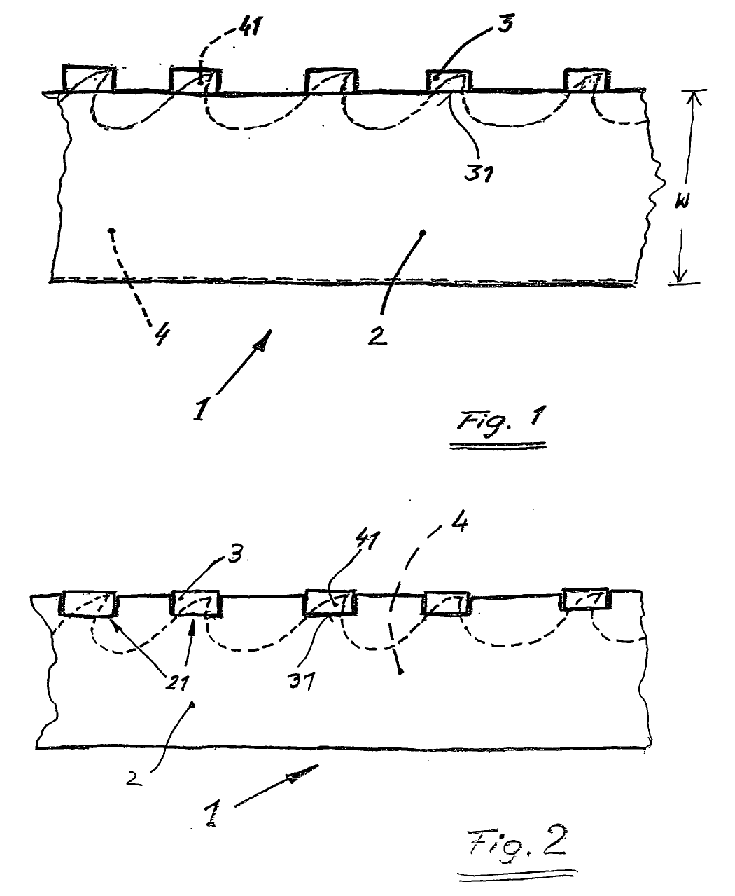

A starting material 1, shown diagrammatically in FIG. 1, is provided for the production of a saw blade 4 (shown by a broken line), which saw blade comprises teeth with tooth tips 41 of a tool steel. Accordingly, a steel band 2 having a width W carries parts 3 of cutting material, in the present case of tool steel, which parts 3 are non-detachably attached to the steel band on the face side thereof, preferably, by means of a welded connection 31.

FIG. 2 shows, also in diagrammatic form, a starting material 1 with depressions 21 provided in a steel band 2. A cutting material part 3 is positioned in each of the depressions 21, which cutting material part is fusion welded to the steel band 2 at least on the base surface 31. A saw to be made from this starting material is shown again by a broken line, whereby a corresponding position of cutting parts 3 in the starting material 1 and the tooth tips 41 of the saw 5 is shown.

It is noted that the foregoing examples have been provided merely for the purpose of explanation and are in no way to be construed as limiting of the present invention. While the present invention has been described with reference to an exemplary embodiment, it is to be understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A starting material for the production of a saw band of tough, elastic steel which saw band comprises saw teeth with tooth tips of hard, wear-resistant material, wherein the starting material comprises a steel band which carries on the face side thereof parts of cutting material.

2. The starting material of claim 1, wherein the parts of cutting material are situated at locations on the steel band that correspond to locations of the tooth tips on the saw band.

3. The starting material of claim 1, wherein the parts of cutting material are connected to the steel band by means of welding.

4. The starting material of claim 3, wherein the welding comprises at least one of electron beam welding, laser welding and resistance pressure welding.

5. The starting material of claim 1, wherein the cutting material comprises a tool steel.

6. The starting material of claim 1, wherein the cutting material comprises a hard metal.

7. The starting material of claim 3, wherein the parts of cutting material are at least partially countersunk into depressions in the steel band.

8. The starting material of claim 4, wherein the steel band has a width of greater than about 15 mm.

9. The starting material of claim 3, wherein the steel band has a width of greater than about 40 mm.

10. A saw band made from the starting material of claim 1.

11. A process for the manufacture of a starting material for a saw band comprising saw teeth with tooth tips of hard, wear-resistant material, which process comprises placing parts of cutting material on the face side of a steel band and connecting the parts to the steel band by means of metallic bonding.

12. The process of claim 11, wherein the parts of cutting material are placed in locations on the steel band that correspond to locations of the tooth tips on the saw band.

13. The process of claim 12, wherein there are substantially no gaps between the parts and the steel band.

14. The process of claim 11, wherein the metallic bonding comprises welding.

15. The process of claim 14, wherein the welding comprises at least one of electron beam welding, laser welding and resistance pressure welding.

16. The process of claim 12, wherein the cutting material comprises a tool steel.

17. The process of claim 12, wherein the cutting material comprises a hard metal.

18. The process of claim 11, wherein depressions are provided in the steel band on the face side thereof and the parts of cutting material are at least partially countersunk into these depressions.

19. The process of claim 18, wherein there are substantially no gaps between the parts and the bases of the depressions.

20. The process of claim 11, wherein the steel band has a width of greater than about 15 mm.

21. The process of claim 20, wherein the steel band has a width of greater than about 40 mm.

22. The process of claim 11, wherein at least one of the length of the individual parts of cutting material and the reciprocal spacing at which the parts are connected to the steel band is provided in accordance with a predetermined tooth profile of the saw.

23. The process of claim 18, wherein at least one of the length of the depressions in the steel band, the length of the individual parts of cutting material and the reciprocal spacing at which the parts are connected to the steel band is provided in accordance with a predetermined tooth profile of the saw.

24. The process of claim 11, wherein the steel band is guided and the parts of cutting material are placed thereon in sequence at predetermined points thereof and welded thereto.

25. The process of claim 11, wherein depressions are provided in the steel band at predetermined locations thereof, the steel band is guided, and the parts of cutting material are placed into the depressions and welded to the steel band.

26. A starting material obtainable by the process of claim 11.

27. A saw band obtainable from the starting material of claim 26.

28. A starting material for the production of a saw band, comprising a steel band which carries on the face side thereof individual parts of cutting material comprising at least one of a tool steel and a hard metal, which parts are connected to the steel band by at least one of electron beam welding, laser beam welding and resistance pressure welding.

29. The starting material of claim 28, wherein the cutting material comprises a high speed steel.

30. The starting material of claim 29, wherein the steel band has a width of greater than about 40 mm.

31. The starting material of claim 30, wherein depressions are present in the steel band and the parts of cutting material are at least partially countersunk into these depressions.
